(19) United States
(12) Patent Application Publication
(10) Pub. No.: US 2026/0298169 A1
(43) Pub. Date: Oct. 1, 2026

(54) AUTOMATIC INJECTOR CUTOUT TOOL

(71) Applicant: Transportation IP Holdings, LLC, Norwalk, CT (US)

(72) Inventors: John Edward Schutt, McKean, PA (US); Randy James McCall, Apple Valley, CA (US)

(73) Assignee: Transportation IP Holdings, LLC, Norwalk, CT (US)

(21) Appl. No.: 19/089,708

(22) Filed: Mar. 25, 2025

(51) Int. Cl. F02D 41/22; F02D 41/30

(52) U.S. Cl. CPC F02D 41/22; F02D 41/3005; F02D 2041/224

(57) ABSTRACT

A diagnostic tool for use with an internal combustion engine may include a control circuit to initiate at least two switches for a corresponding two injectors and further to execute a cutout timing sequence via selective initiation of the at least two switches. A system for use with the diagnostic tool can include a harness selectively positioned in-line with the diagnostic tool. A method for a cylinder cutout test may include automatically activating a first switch for a first fuel injector of a first cylinder of an engine for a first duration and deactivating thereafter, automatically activating a second switch for a second fuel injector of a second cylinder of the engine for a second duration and deactivating thereafter, and recording and/or storing a crankcase pressure during the cylinder cutout test for analysis by a control circuit.

### BACKGROUND

### Technical Field.

This disclosure relates to a diagnostic tool for evaluating an engine.

### Discussion Of Art.

An engine, such as a diesel engine, may include a fuel system including a plurality of fuel injectors. A fuel injector may be coupled to each cylinder of a multi-cylinder engine. Each fuel injector may be adapted to inject a pulse of fuel into the cylinder at a different time in an engine cycle, according to a cylinder firing order. Injectors may age and degrade or become faulty over time. A cylinder cutout test, which may also be referred to as an injector cutout test or a power balance test, for example, may be used to evaluate an engine to identify which injector(s) may be faulty.

To perform a cylinder cutout test, an operator manually disconnects the injector harness from each injector in a specified order. In such instances, the operator moves around the engine to manually unplug the coupling at each injector. This may be tedious and/or inconvenient for the operator, especially for larger engines. It may be desirable to have a diagnostic tool and method for performing a cylinder cutout test that differs from those that are currently available.

### BRIEF DESCRIPTION

One general aspect includes a diagnostic tool for use with an internal combustion engine.

Embodiments of this aspect include the diagnostic tool comprising a control circuit configured to initiate at least two switches for a corresponding two injectors and further configured to execute a cutout timing sequence via selective initiation of the at least two switches. Other embodiments of this aspect include corresponding computer systems, apparatus, and computer programs recorded on one or more computer storage devices, each configured to perform the cutout timing sequence for the cylinder cutout test.

Embodiments of this aspect further include the at least two switches (e.g. normally-closed relays) comprising a first switch to selectively depower a first injector and a second switch to selectively depower a second injector.

One general aspect includes a system including a plurality of fuel injectors for cylinders of an engine; an injection harness electrically connectable to the plurality of fuel injectors; and a diagnostic tool configured to communicate with the injection harness. The diagnostic tool may include a control circuit configured to initiate at least two switches for a corresponding two injectors and further configured to execute a cutout timing sequence via selective initiation of the at least two switches. Other embodiments of this aspect include corresponding computer systems, apparatus, and computer programs recorded on one or more computer storage devices, each configured to perform the cutout timing sequence for the cylinder cutout test.

One general aspect include a method for a cylinder cutout test. The method includes automatically activating a first switch for a first fuel injector of a first cylinder of an engine for a first duration and deactivating thereafter; automatically activating a second switch for a second fuel injector of a second cylinder of the engine for a second duration and deactivating thereafter, and recording a crankcase pressure during the cylinder cutout test. Other embodiments of this aspect include corresponding computer systems, apparatus, and computer programs recorded on one or more computer storage devices, each configured to perform the actions of the methods.

### BRIEF DESCRIPTION OF THE DRAWINGS

The subject matter described herein may be understood from reading the following description of non-limiting embodiments, with reference to the attached drawings, wherein:

FIG. 1 is a schematic diagram of a vehicle with an engine according to at least one aspect.

FIG. 2 a block diagram of a diagnostic tool coupled to an injection harness and a user interface, according to at least one aspect.

FIG. 3 is a flowchart depicting a method for a cylinder cutout test, according to at least one aspect.

### DETAILED DESCRIPTION

Aspects of the present disclosure are directed to tools, systems and methods for operating, controlling and/or diagnosing an engine and, in various aspects, one or more fuel injectors thereof. For clarity of illustration, a locomotive is provided as an example of a vehicle that is supporting a system incorporating an embodiment of a diagnostic tool for an engine. In one embodiment, a diagnostic tool may be connected to a fuel injection harness of an engine. The diagnostic tool may include a control circuit to energize a plurality of switches to perform an automatic cylinder cutout test. More specifically, the plurality of switches may be selectively actuated to selectively remove power from the injectors according to a cutout timing sequence. Output from the diagnostic tool may be stored in a memory and/or communicated to an operator.

For example, a system may include a plurality of fuel injectors for cylinders of an engine, an injection harness electrically connectable to the plurality of fuel injectors, and a diagnostic tool configured to communicate with the injection harness. The diagnostic tool may include a control circuit that can initiate at least two switches for a corresponding two injectors and further configured to execute a cutout timing sequence via selective initiation of the at least two switches. In at least one aspect, the diagnostic tool is selectively detachable from and in-line with the injection harness. Additionally or alternatively, the system may include a pressure sensor that can determine a crankcase pressure of the engine. Out-of-range data from the pressure sensor may be associated with a faulty injector, for example, which may be identifiable from the timing of the out-of-range data relative to the cutout timing sequence.

Such a diagnostic tool may automatically disconnect each injector during the cylinder cutout test. Therefore, the operator need not manually move around the engine to physically disconnect each injector. Additionally, in various aspects, the cut-out and cut-in timing is optimized and implemented efficiently by a timer circuit. In certain instances, more than one cutout timing sequence may be performed for different purposes and/or comparative data.

In other embodiments, alternative platforms and vehicles are contemplated. Suitable vehicles may include rail vehicles (such as a locomotive or switcher, automobiles, trucks (with or without trailers), buses, marine vessels, aircraft, unmanned aircraft (e.g., drones), mining vehicles, agricultural vehicles, or other off-highway vehicles. Vehicle systems described herein (rail vehicle systems or other vehicle systems that do not travel on rails or tracks) may be formed from a single vehicle or multiple vehicles. With respect to multi-vehicle systems, the vehicles may be mechanically coupled with each other (e.g., by couplers), or virtually or logically coupled but not mechanically coupled. For example, vehicles may be logically but not mechanically coupled when the separate vehicles communicate with each other to coordinate movements of the vehicles with each other so that the vehicles travel together (e.g., as a convoy, swarm, consist, platoon). Calculations and computations, such as navigation processes, may be performed on-board the vehicle systems or off-board the vehicle systems and then communicated to the vehicle systems. Whether on-board or off-board, a vehicle control system may operate a vehicle system and receive and process sensor inputs, operator inputs, operational parameters, vehicle parameters, and route parameters, etc.

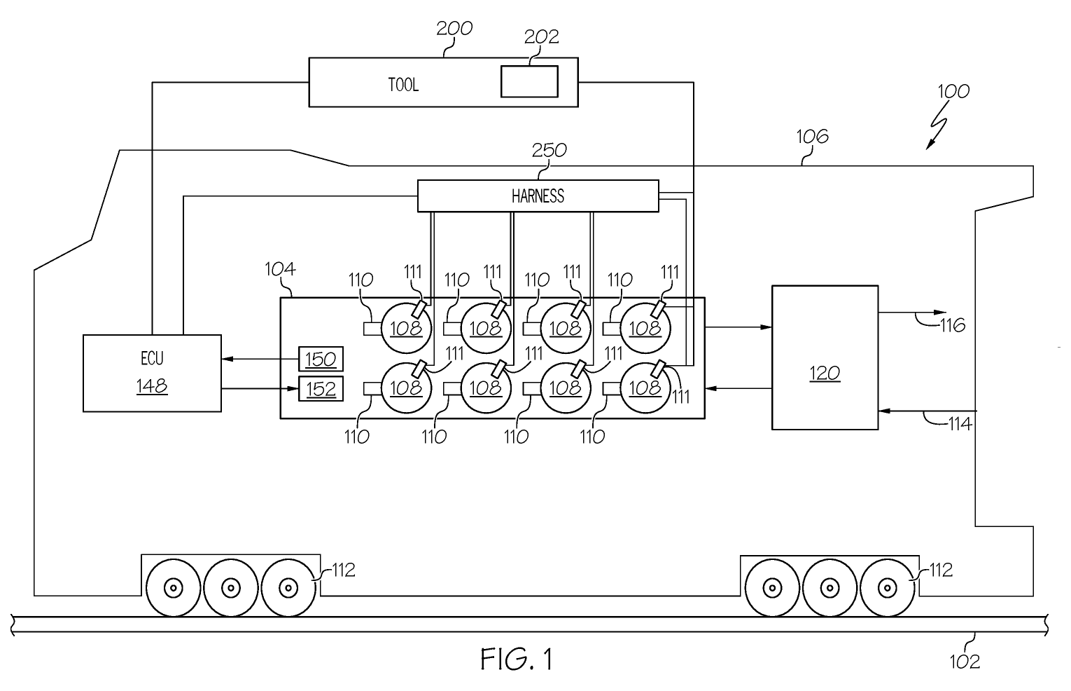

Referring to FIG. 1, a system 100 includes an engine 104, which is installed in a vehicle 106. Although the vehicle depicted in FIG. 1 is a rail vehicle including a plurality of wheels 112 on a rail 102, alternative vehicles are contemplated, as further described herein. The engine may be an internal combustion engine and, in other instances, a multi-fuel engine operating with diesel fuel and natural gas, for example. In other examples, the engine may use various combinations of fuels other than diesel and natural gas (such as any combination of diesel, gasoline, natural gas, or other fuel blends). In yet another embodiment, the engine may be a single-fuel engine operating with only one fuel.

The engine receives intake air for combustion from an intake passage 114. The intake passage receives ambient air from an air filter that filters air from outside of the vehicle. Exhaust gas resulting from combustion in the engine is supplied to an exhaust passage 116. Exhaust gas flows through the exhaust passage and out of an exhaust stack of the vehicle.

The system includes a turbocharger 120 that is arranged between the intake passage and the exhaust passage. The turbocharger increases air charge of ambient air drawn into the intake passage in order to provide greater charge density during combustion to increase power output and/or engine-operating efficiency. The turbocharger may include a compressor that is at least partially driven by a turbine. While in this case a single turbocharger is shown, other systems may include multiple turbine and/or compressor stages. In other embodiments, the engine may be naturally-aspirated receiving fresh air charge for in-cylinder combustion and not include a turbocharger.

An engine control unit (ECU) 148 (e.g., electronic controller having one or more processors) may be employed to control various components related to the vehicle. In one example, the ECU includes a computer. The ECU further includes computer readable storage media (e.g., memory) including code for enabling on-board monitoring and control of rail vehicle operation. The ECU, while overseeing control and management of the vehicle system, may receive signals from a variety of sensors, as further elaborated herein, to determine operating parameters and operating conditions, and correspondingly adjust various engine actuators 152 to control operation of the vehicle. For example, the ECU may receive signals from various engine sensors including, but not limited to, crank case pressure, engine speed, engine torque output, engine load, boost pressure, exhaust pressure, ambient pressure, exhaust temperature, knock, misfire, and the like. Correspondingly, the ECU may control aspects and operations of the vehicle system by sending commands to various components such as traction motors, alternator or generator, cylinder valves, air and/or fuel throttle, fuel injectors, and the like.

As shown in FIG. 1, the engine includes a plurality of cylinders 108. Though FIG. 1 depicts an engine with eight cylinders, other numbers of cylinders are contemplated. Each cylinder of the engine include a knock sensor 110 and a fuel injector 111. Each fuel injector may inject fuel into the cylinder to which it is coupled at a different time than the other fuel injectors, for example. The order in which each fuel injector fires (e.g., injects fuel into the corresponding cylinder) may be referred to herein as the cylinder firing order. For a single engine cycle, each fuel injector may fire at a different time within the cylinder firing order. For example, each fuel injector may deliver one primary injection into the cylinder which it is coupled to in a single engine cycle. The fuel may be delivered to the fuel injectors from a high-pressure fuel system including a fuel tank, fuel pumps, and a fuel rail or injection harness 250.

The engine includes one knock sensor for each cylinder, and each individual cylinder knock sensor may measure data associated with the cylinder to which it is coupled. In one example, the knock sensor may be a strain gauge-based or accelerometer-based knock sensor. The knock sensor may output a voltage, which is then received as a voltage signal at the ECU. In one embodiment, the ECU processes the voltage signal from the knock sensor to determine a corresponding indicated mean effective pressure (IMEP) value and/or peak cylinder pressure (PCP) value (or a maximum acceleration value associated with the PCP) for the individual cylinder to which the knock sensor is coupled. Thus, the ECU receives data from each knock sensor of each engine cylinder of the engine and processes the received data to indicate engine cylinder knock, determine the indicated IMEP and/or PCP, and subsequently adjust engine operation based on the received data. In another example, the ECU may determine cylinder misfire based on the output of the knock sensors, a crankshaft position output, and a known cylinder firing order of the engine (e.g., the cylinder number order in which fuel is injected into each cylinder and then combusted).

Referring still to FIG. 1, the engine includes a crankcase sensor 150, which detects the pressure of gases in the crankcase of the engine. The crankcase sensor is communicatively coupled to the ECU to provide data to the ECU. The crankcase sensor may output a voltage, which is then received as a voltage signal at the ECU. In various instances, the crankcase sensor is physically and/or communicatively coupled to the injection harness. In certain instances, the data collected by the crankcase sensor can be transmitted to the ECU and/or to a diagnostic tool directly and/or indirectly (e.g. via the injection harness), as further disclosed herein. Variations in crankcase pressure and/or readings outside an expected range may be indicative of potential issues, such as a leak or faulty injector, for example. In various instances, the crankcase sensor is located on the engine block. The crankcase sensor may be a pressure sensor, and may include a strain gauge-based or accelerometer-based pressure sensor, for example.

A diagnostic tool 200 is coupled to the engine and the ECU. The diagnostic tool is for use with the engine during a testing operation. In various instances, the diagnostic tool is releasably or selectively coupled to the engine. The diagnostic tool may be indirectly coupled to the engine via the injection harness. As shown in FIG. 1, the diagnostic tool is coupled to the engine via the injection harness and the ECU. In various aspects, the diagnostic tool is directly coupled to the injection harness and is indirectly coupled to the ECU via the injection harness. The diagnostic tool may be in-line with the injection harness. For example, the diagnostic tool can be electrically and physically connected to first and second harness connectors 252, 254, which connect the injection harness to the ECU and the engine.

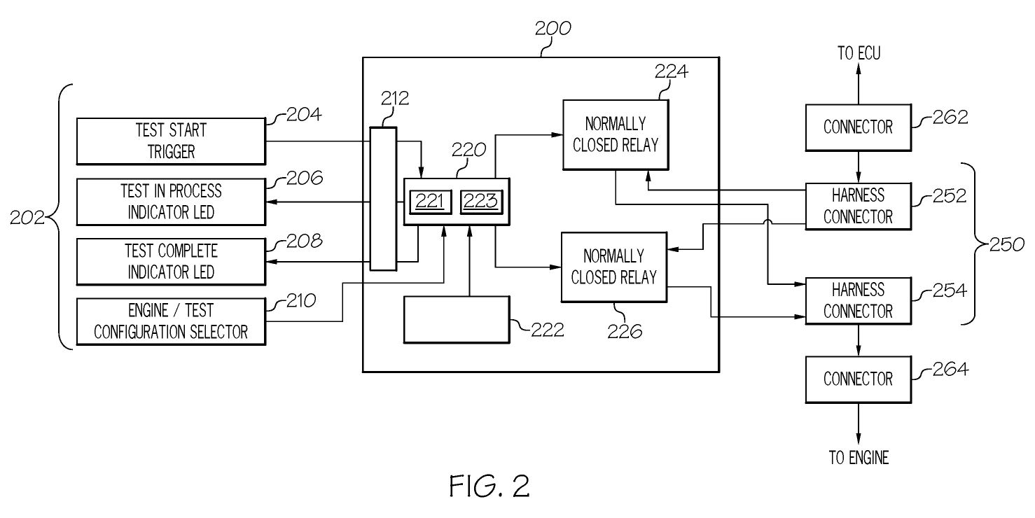

Referring primarily to FIG. 2, the diagnostic tool includes a control circuit 220 that can initiate at least two switches 224, 226 for a corresponding at least two injectors. The control circuit is to execute a cutout timing sequence for the at least two injectors via selective initiation of the at least two switches. A programmable microchip may include the control circuit and, in such instances, may be programmed to selectively and/or sequentially activate the switches. Although two switches are shown in FIG. 2, additional switches are contemplated. For example, each injector can be paired with a corresponding switch for selective depowering of the injector.

The switches may be normally-closed relays. Initiation of a relay switch corresponds to energizing of the relay, for example, which may remove the power from the respective injector corresponding to that relay.

The control circuit may communicate with an input/output circuit 212, which is in signal communication with a user interface 202 for receiving operator input and/or providing status information to the operator. The user interface may include a keyboard and/or input device and/or an output device, such as a display, indicator light, and/or screen, which may be touch screen, for example. The input circuit receives operator input via the user interface, for example. The user interface may include a test start actuator 204 for initiating a test and an engine/test configuration selection actuator 210 for selecting a particular test for implementation by the control circuit. The user interface may further include indicators, such as a test in-progress indicator LED 206 and a test complete indicator LED 208, for example.

In various instances, the input/output circuit may be integrated with each other and, in other instances, the input circuitry may be separate from the output circuitry. In various aspects, a test status indicated at the user interface by the input/out circuit may be in-progress, complete, in-range performance, out-of-range performance, and error, for example.

The test status determined by the control circuit may be the status of one or more of the injectors, switches, a timing of the cutout timing sequence, or a performance parameter of the engine, for example.

The control circuit further includes a memory 221 storing the cutout timing sequence and a timer circuit 223 for communication with the memory and operatively coupled to the at least two switches. The control circuit can acquire an input signal from the input circuit and sequentially activate the plurality of switches based on the cutout timing sequence stored in the memory. In various instances, more than one cutout timing sequence may be stored in the memory. The engine/test configuration selection actuator may be used to select the desired cutout timing sequence based on the desired test and/or desired injectors/cylinders to test.

The at least two switches include a first switch to selectively depower, or cutout, a first injector and a second switch to selectively depower, or cutout, a second injector. However, the reader will appreciate that additional switches may be incorporated into the diagnostic tool for selective depowering of additional injectors.

The diagnostic tool further includes at least two electrical connectors for attaching the diagnostic tool to the injection harness of the engine. For example, the diagnostic tool includes a first harness connector 252 for connection to an ECU connection 262 to the ECU, and a second harness connector 254 for connection to an engine connection 264 to the engine.

The control circuit can acquire a signal from the crankcase sensor in the engine and process the signal to determine a crankcase pressure during the cutout timing sequence. In various instances, the sensor is indicative of crankcase pressure. For example, referring again to FIG. 1, the diagnostic tool is coupled to the engine via the injection harness and the engine includes the crankcase sensor, which detects the pressure of gases in the crankcase of the engine.

In various instances, a method for a cylinder cutout test may include an automatic cylinder cutout test, which may utilize an automatic cylinder cutout tool, such as the diagnostic tool 200 (FIGS. 1 and 2). The method may include automatically activating a first switch for a first fuel injector of a first cylinder of an engine for a first duration and deactivating thereafter, automatically activating a second switch for a second fuel injector of a second cylinder of the engine for a second duration and deactivating thereafter, and recording a crankcase pressure during the cylinder cutout test.

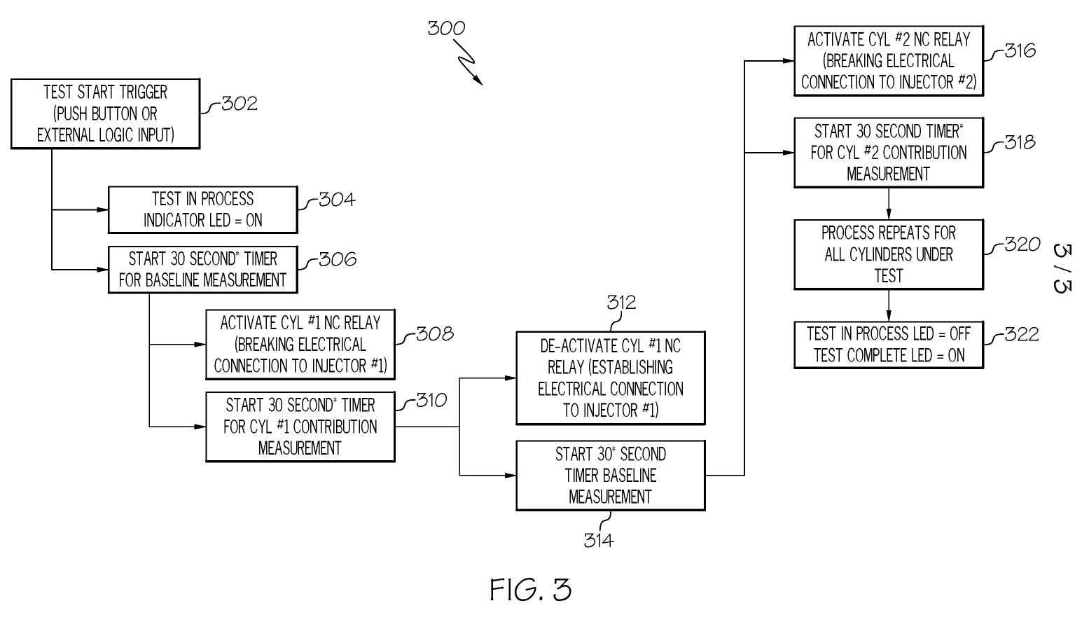

An exemplary method 300 is depicted in FIG. 3. The method 300 includes performing an automatic cylinder cutout test with a diagnostic tool mechanically connected to an injection harness for an engine where the diagnostic tool comprises a control circuit including a timer circuit. The method includes initiating the automatic cylinder cutout test upon actuation, at 302, of a trigger. Actuation of the trigger may be in the form of an actuation button being pushed by an operator or external logic input being transmitted to the control circuit. Upon initiation of the automatic cylinder cutout test, a test in-progress indicator LED is activated, at 304, and a baseline timer is initiated for a baseline duration, at 306, for obtaining baseline measurement data (e.g. baseline crankcase pressure) prior to expiration of the baseline timer.

Thereafter, the automatic cylinder cutout test selective activates and deactivates a plurality of switches associated with each cylinder of the engine. More specifically, upon activation of a first switch, at 308, a first timer is initiated, at 310, for a first duration. Activation of the first switch effects depowering of a first injector of the engine. The first switch is deactivated, at 312, upon expiration of the first timer. At 314, a transitional timer is initiated for an transitional duration and a second switch is activated, at 316, upon expiration of the transitional timer. Activation of the second switch effects depowering of a second injector of the engine.

A second timer is initiated, at 318, for a second duration, and the second switch is deactivated thereafter upon expiration of the second timer. The foregoing process of activating and deactivating additional switches according to a timer cutout sequence is repeated, at 320, for each additional injector of the engine being tested,

Upon completion of the timer cutout sequence by the control circuit, at 322, the test in-progress LED is turned off and the test complete LED is turned on. Alternative indicator lights may be incorporated into the diagnostic tool to communicate test status to the operator throughout and/or upon completion of the automatic cylinder cutout test.

In various instances, test data is recorded during the automatic cylinder cutout test. For example, crankcase pressure may be monitored and recorded during the automatic cylinder cutout test.

In various aspects, prior to initiating the automatic cylinder cutout test, the diagnostic tool is connected to an injection harness of the engine. The injection harness may electrically couple the diagnostic tool to the engine and to the ECU. In other instances, the diagnostic tool may be directly coupled to the ECU.

In various instances, the first duration for the first timer equals the second duration for the second timer such that the first and second cylinders are cutout for the same amount of time. Additionally or alternatively, in certain instances, the transition duration equals the baseline duration. In certain instances, the baseline duration is equal to at least one of the first duration, the second duration, and the transition duration. In various instances, the first duration, the second duration, the third duration, and/or the baseline duration are equal. For example, the duration for each timer may be 30 seconds. In other instances, the duration may be less than 30 seconds. In certain instances, the duration for at least one of the timers may be different from at least one other timer duration.

The sequential activation and deactivation of switches throughout the cylinder cutout test may be set and controlled down to a fraction of a second (e.g. to a microsecond), which may make the test results more accurate and/or reliable in certain instances.

In various instances, the method 300 further includes correlating, by a control circuit, a cylinder fault for at least one of tested/cutout cylinders based on the crankcase pressure recorded during the cylinder cutout test.

In certain instances, the method 300 further includes adjusting at least one of the timer durations based on the desired diagnostic test. In various instances, upon adjustment of at least one of the durations (e.g. of the first timer or the second timer), the method may further include re-running the diagnostic test with the updated duration(s). For example, the method may include re-activating the first switch of the first fuel injector of the first cylinder of the engine for the updated first duration and deactivating thereafter, re-activating the second switch of the second fuel injector of the second cylinder of the engine for the updated second duration and deactivating thereafter.

In various aspects, the method 300 further includes calculating, by a control circuit, a first mean crankcase pressure over the first duration of the first timer and a second mean crankcase pressure over the second duration of the second timer; and associating, by the control circuit, the first mean crankcase pressure and the second mean crankcase pressure to the cutout of one of the cylinders. In various instances, the method further includes comparing, by the control circuit, the first mean crankcase pressure and the second mean crankcase pressure. Comparing the mean crankcase pressures over the first duration and the second duration may be indicative of a condition of the cutout cylinder during the selected duration, for example.

In various aspects, the method may include identifying outlier data or an anomaly in crankcase pressure during the cylinder cutout test; and transmitting, based on the anomaly, a signal to effect at least one effect. The effect may be cutting out at least one cylinder, adjusting a firing sequence for the cylinders, derating the engine, or providing a recommendation and/or a warning to an operator via the user interface. An anomaly may be a crankcase pressure that is outside of an expected threshold and/or range, for example, and/or a deviation from the crankcase pressure detected throughout the diagnostic test, for example. In various instances, the expected threshold and/or range may be adjusted during the diagnostic test based on the detected crankcase pressures at various times during the test, for example.

In various instances, the output or data from the cylinder cutout test can be stored in the memory of the diagnostic tool and identified by a serial number, date/time, or other identifying information for the engine and the test. In certain instances, the output/data can be transmitted and stored in a memory for the engine and/or ECU. The results of the cylinder cutout test can be compared to historical data over the lifetime of the engine or a portion of the engine’s life. In various instances, such data can be analyzed, by a control circuit, to determine a deterioration rate of the engine by comparing the engine to itself at one or more points in time, for example.

The terms "control circuit" and “controller” are substitutable with each other and encompasses hardwired circuitry, programmable logic (such as microprocessors, microcontrollers, digital signal processors (DSPs), programmable logic devices (PLDs), programmable gate arrays (PGAs), or field-programmable gate arrays (FPGAs)), state machines, or firmware that executes stored instructions. Control circuits may form part of larger systems, such as integrated circuits (ICs), application-specific integrated circuits (ASICs), or systems-on-chips (SoCs), and may be found in devices such as computers, smartphones, wearable devices, and servers. These circuits may perform tasks involving data processing, communication, or data storage. Depicted components, functions, or operations may be implemented using hardware, software, firmware, or combinations of two or more thereof.

In one embodiment, the control circuits or systems described herein may have a local data collection system deployed and may use machine learning to enable derivation-based learning outcomes. The controllers may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used making determinations, calculations, comparisons and behavior analytics, and the like.

In one embodiment, the control circuit may include a policy engine that may apply one or more policies. These policies may be based at least in part on characteristics of a given item of equipment or environment. With respect to control policies, a neural network can receive input of a number of environmental and task-related parameters. These parameters may include, for example, operational input regarding operating equipment, data from various sensors, location and/or position data, and the like. The neural network can be trained to generate an output based on these inputs, with the output representing an action or sequence of actions that the equipment or system should take to accomplish the goal of the operation. During operation of one embodiment, a determination can occur by processing the inputs through the parameters of the neural network to generate a value at the output node designating that action as the desired action. This action may translate into a signal that causes the vehicle to operate. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models is obtained, it may be evaluated on their performance using a determined success metric. The best model is selected, and the vehicle controller executes that plan to achieve the desired input data to mirror the predicted best outcome scenario. Additionally, the success metric may be a combination of the optimized outcomes, which may be weighed relative to each other.

In one embodiment, data may be generated, transmitted, and stored and may involve one or both of a protected space data source and the exposed space data source. The control circuit may encrypt and decrypt data as needed at rest, during use, or in transit. Encryption keys and schema may be selected and implemented as informed by end use parameters and requirements. The control circuit may evaluate and/or identify a decision boundary (that is, a boundary that separates desired behavior from undesired behavior) with regard to that data. If the control circuit determines that some quantity of data is from a protected space data source and/or is operating within determined boundaries then the control circuit, and the equipment being controlled, may operate normally. However, if the data is determined to be from an exposed space data source and/or it crosses the decision boundary, the control circuit may respond. Suitable responses may be to power down determined equipment, signal an alert, run a diagnostic routine, perform a data backup (without overwriting existing backup data), isolate equipment (including by suspending some or all communication pathways), switch equipment or control operations to a safe mode of the control system, and/or initiate a safe mode state of the equipment (e.g., slow a vehicle to a safe and controlled stop). The safe mode may be, in one embodiment, a soft shutdown mode that it intended to avoid damage or injury based on the shutdown itself and in another embodiment may be a reboot and/or minimal reload of essential drivers and functionality.

In one embodiment, vehicle systems may implement secure authentication processes, encryption protocols, and firewalls to protect against unauthorized access or spoofing. A suitable control circuit may include a security module responsible for detecting and responding to suspicious activities, such as unapproved data access attempts or irregular communication patterns. This module may employ machine learning to adapt its defense strategies, learning from previous attacks and adjusting security measures as needed to prevent similar breaches.

Vehicle systems in various embodiments may use a combination of local and remote sensors to monitor environmental conditions, vehicle status, and external inputs. These sensors may detect parameters such as speed, acceleration, braking status, location, proximity to other objects or vehicles, ambient temperature, humidity, and lighting conditions. Raw data gathered by these sensors may feed into the control circuit, which in turn may respond to the input. The responses may include dynamically adjusting vehicle operations in response to real-time or near real-time changes in the environment or vehicle parameters; and, processing the data for further analysis. In certain embodiments, sensors may utilize various types of communication protocols (e.g., Bluetooth, ZigBee, Wi-Fi, or cellular networks) to share data with control systems both within the vehicle and to external data processing centers.

In certain embodiments, maintenance and diagnostic functions may be integrated into the control circuit, enabling the system to self-monitor for operational health. The control circuit may utilize diagnostic algorithms to assess the status of various vehicle components, such as engines, brakes, batteries, fuel cells and fuel systems, propulsion systems, and electronic systems (if present). If a component is found to be underperforming or at risk of failure, the control circuit may schedule alerts, recommend maintenance, or initiate safety protocols to avoid catastrophic failure. Self-diagnostics may use historical performance data to identify trends, facilitating proactive rather than reactive maintenance.

Terms such as "processing," "computing," "calculating," or "determining" refer to operations carried out by the control circuit, which may include computing systems or electronic devices that manipulate data represented as physical (electronic) quantities within memory or registers. One or more components may be described as "configured to," "configurable to," "operable/operative to," "adapted/adaptable to," or similar terms. Unless explicitly stated, these terms encompass components in both active and inactive states. Unless stated otherwise, terms like "including" or "having" should be interpreted as open-ended (i.e., "including but not limited to"). Numeric claim recitations generally mean "at least" the stated number, and disjunctive terms like "A or B" should be interpreted to include either or both unless explicitly specified. Operations in any claim may generally be performed in any order unless explicitly stated. The recitation "at least one of A, B, and C" should be interpreted as any combination of A, B, and C, such A alone, B alone, C alone, A and B together, A and C together, B and C together, and/or A, B, and C together. The recitation "at least one of A, B, or C" should be interpreted to include A alone, B alone, C alone, A and B together, A and C together, B and C together, and/or A, B, and C together.

This written description may disclose several embodiments of the subject matter, including the best mode, and may enable one of ordinary skill in the relevant art to practice the embodiments of subject matter, including making and using any devices or systems and performing any incorporated methods. The patentable scope of the subject matter is defined by the claims, and may include other embodiments that may occur to one of ordinary skill in the art. Such other embodiments may be intended to be within the scope of the claims if they may have structural elements that may not differ from the literal language of the claims, or if they may include equivalent structural elements with insubstantial differences from the literal languages of the claims.

What is claimed is:

1. A diagnostic tool for use with an internal combustion engine, the diagnostic tool comprising a control circuit configured to initiate at least two switches for a corresponding two injectors and further configured to execute a cutout timing sequence via selective initiation of the at least two switches.

2. The diagnostic tool of claim 1, the at least two switches comprise:
a first switch to selectively depower a first injector; and
a second switch to selectively depower a second injector.

3. The diagnostic tool of claim 1, wherein the control circuit is configured to determine a test status of one or more of the injectors, switches, a timing of the cutout timing sequence, or a performance parameter of the internal combustion engine.

4. The diagnostic tool of claim 3, further comprising an output circuit to indicate the test status, wherein the output circuit comprises an indicator light.

5. The diagnostic tool of claim 3, wherein the test status is indicated as one or more of in-progress, complete, in-range performance, out-of-range performance, and error.

6. The diagnostic tool of claim 1, wherein the at least two switches comprises at least one normally-closed relay.

7. The diagnostic tool of claim 1, further comprising a first array of electrical connectors to attach to an injection harness of the internal combustion engine.

8. The diagnostic tool of claim 7, wherein the control circuit is further configured to:
acquire a signal from a sensor, wherein the signal is indicative of crankcase pressure; and
process the signal to determine crankcase pressure during the cutout timing sequence.

9. A system, comprising:
a plurality of fuel injectors for cylinders of an engine;
an injection harness electrically connectable to the plurality of fuel injectors; and
a diagnostic tool configured to communicate with the injection harness, the diagnostic tool comprising a control circuit configured to initiate at least two switches for a corresponding two injectors and further configured to execute a cutout timing sequence via selective initiation of the at least two switches.

10. The system of claim 9, wherein the diagnostic tool is selectively detachable from and in-line with the injection harness.

11. The system of claim 9, further comprising a pressure sensor configured to determine a crankcase pressure of the engine.

12. A method for a cylinder cutout test, the method comprising:
automatically activating a first switch for a first fuel injector of a first cylinder of an engine for a first duration and deactivating thereafter;
automatically activating a second switch for a second fuel injector of a second cylinder of the engine for a second duration and deactivating thereafter; and
recording a crankcase pressure during the cylinder cutout test.

13. The method of claim 12, further comprising correlating, by a control circuit, a cylinder fault for at least one of the first cylinder and the second cylinder based on the crankcase pressure recorded during the cylinder cutout test.

14. The method of claim 12, further comprising adjusting at least one of the first duration and the second duration.

15. The method of claim 14, further comprising, upon adjustment of at least one of the first duration and the second duration:
re-activating the first switch of the first fuel injector of the first cylinder of the engine for the first duration and deactivating thereafter; and
re-activating the second switch of the second fuel injector of the second cylinder of the engine for the second duration and deactivating thereafter.

16. The method of claim 12, further comprising:
calculating, by a control circuit, a first mean crankcase pressure over the first duration and a second mean crankcase pressure over the second duration; and
associating, by the control circuit, the first mean crankcase pressure and the second mean crankcase pressure to cutout of a cylinder selected from a group consisting of the first cylinder and the second cylinder.

17. The method of claim 16, further comprising comparing, by the control circuit, the first mean crankcase pressure and the second mean crankcase pressure.

18. The method of claim 12, further comprising:
identifying, by a control circuit, an anomaly in crankcase pressure during the cylinder cutout test; and
transmitting, based on the anomaly, a signal to effect at least one effect selected from a group consisting of cutting out at least one cylinder, adjusting a firing sequence, derating the engine, providing a recommendation or a warning to a user interface.

19. The method of claim 12, further comprising activating and deactivating additional switches of the plurality of switches for each additional injector of the engine to selectively depower each additional injector of the engine.

20. The method of claim 12, further comprising connecting a test tool to an injection harness mechanically coupled to an internal combustion engine, the test tool comprising a timer circuit and a plurality of switches comprising the first switch and the second switch, wherein the timer circuit is configured to sequentially activate the first switch for the first duration and the second switch for the second duration.
